(19) United States
(12) Patent Application Publication
(10) Pub. No.: US 2011/0269360 A1
(43) Pub. Date: Nov. 3, 2011

(54) CUT RESISTANT FABRIC

(76) Inventor: Elisabeth Mueller, Berlin (DE)

(21) Appl. No.: 13/000,503

(22) PCT Filed: Jun. 23, 2009
(86) PCT No.: PCT/EP2009/057772

§ 371 Date: Mar. 28, 2011

(30) Foreign Application Priority Data
Jun. 24, 2008 (EP) 08011394.7

(51) Int. Cl. D03D 15/00; D06B 1/00; D02G 3/00; B32B 3/00; D04B 1/14

(52) U.S. Cl. 442/187; 428/221; 442/307; 428/364; 28/217; 57/258

(57) ABSTRACT

The invention relates to a cut resistant fabric comprising polyethylene fibers wherein said fibers are at least partially coated with a polymeric sheath comprising a fluoropolymer. The invention relates further to articles and in particular to articles of apparel and rugged outerwear comprising the inventive fabric. Examples of such articles include but are not limited to gloves, aprons, chaps, pants, boots, gators, shirts, jackets, coats, socks, shoes, undergarments, vests, waders, hats, gauntlets, and the like. The invention also relates to the use of the inventive fabric in articles of apparel and rugged outerwear and in particular in the examples mentioned hereinabove. In particular, the invention relates to gloves comprising the fabric of the invention.

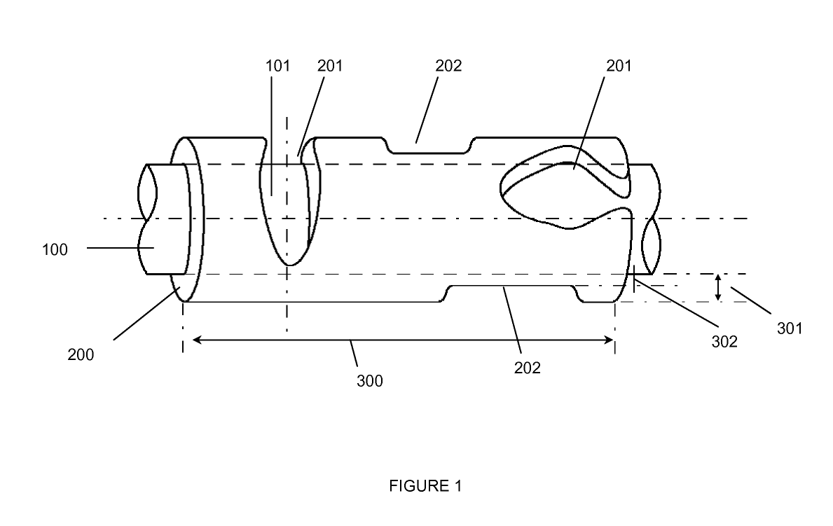

The invention relates to a cut resistant fabric comprising polyethylene fibers. The invention further relates to articles of apparel made therefrom.

An example of a cut resistant fabric is provided by U.S. Pat. No. 5,721,179 disclosing a fabric made by weaving or knitting yarns comprising ultrahigh molecular weight polyethylene (UHMWPE) fibers. A further example is known from US 2007/0249250 wherein a fabric comprising a yarn containing a core of polyethylene coated with polytetrafluoroethylene is disclosed.

Although providing satisfactory resistance against cutting, there is always a need for further improving the cut resistance of the known fabrics such as the above. There is also a need for cut resistance fabrics comprising polyethylene fibers which are more versatile, i.e. fabrics that can be used in a broader range of applications wherein their cut resistance property is primarily needed.

The above needs are fulfilled by the present invention with a cut resistant fabric comprising polyethylene fibers characterized in that said fibers are at least partially coated with a polymeric sheath comprising a fluoropolymer, said sheet having a thickness of at least 10 nm.

The invention also relates to a cut resistant fabric comprising yarns, said yarns containing individual polyethylene fibers characterized in that said individual fibers are at least partially coated with a polymeric sheath comprising a fluoropolymer, said sheet having a thickness of at least 10 nm.

It was surprisingly found that the cut resistance of the fabric of the invention is improved when compared to known fabrics made of bare polyethylene fibers or to known fabrics wherein the yarns are coated rather than the individual fibers contained by the yarns. Therefore, the inventive fabric can be used in a broader range of applications without the need of further modifying it, e.g. by additional treatment or coating of the fabric in order to make it suitable therefor. Hence, the inventive fabric is more versatile.

A further advantage of the inventive fabric is that it can be manufactured with a reduced thickness yet still providing the same resistance against cutting, in particular against cutting with sharp objects.

It was also observed that the inventive fabric shows an increased flexibility compared to known fabrics, in particular to known fabrics where films comprising a fluoropolymer were laminated thereon or even to known fabrics where the yarns were coated rather than the individual fibers. Without being bound to any explanation, it is presumed that the increased flexibility of the inventive fabric stems from the fact that the coated polyethylene fibers are not restricted in their movement, being able to pivot at e.g. the cross-overs one with respect to its adjacent neighbors. Therefore, the inventive fabric provides an increased comfort when used in articles of apparel.

By fiber is herein understood an elongate body, the length dimension of which is much greater that the transverse dimensions of width and thickness. Accordingly, the term fiber includes filament, ribbon, strip, band, tape, and the like having regular or irregular cross-sections. The fibers may have continuous lengths, known in the art as filaments, or discontinuous lengths, known in the art as staple fibers. Staple fibers are commonly obtained by cutting or stretch-breaking filaments. A yarn for the purpose of the invention is an elongated body containing many individual fibers. By individual fiber is herein understood the fiber as such.

The fibers contained by the fabric of the invention are preferably filaments, more preferably staple fibers. It was observed that a fabric manufactured from yarns containing staple fibers shows in addition to the above mentioned advantages also an improved comfort.

According to the invention, the fabric comprises coated polyethylene fibers that is to say coated individual polyethylene fibers. Preferably, at least 50 mass %, more preferably at least 75 mass %, even more preferably at least 95 mass % of the polyethylene fibers are coated. The mass % of the coated polyethylene fibers is the percentage calculated from the total mass of polyethylene fibers contained in the inventive fabric. Said mass percentage can be varied for example by manufacturing the fabric from for example yarns containing only coated polyethylene fibers combined with yarns containing non-coated polyethylene fibers. Alternatively, yarns containing both coated and non-coated polyethylene fibers in the desired mass percentage can be used to manufacture the inventive fabric. The advantage of a fabric containing both coated and non-coated polyethylene fibers is that in addition to improved cut resistance and comfort, said fabric also shows good coatability and printability allowing for the application of different coatings, e.g. polyurethane or latex coatings, or coloring thereof, e.g. for aesthetic reasons.

Most preferably all polyethylene fibers in the inventive fabric are coated. The advantage thereof is that said fabric presents an even further increased comfort while showing improved cut resistance.

Preferably, the coated polyethylene fibers comprise coated staple polyethylene fibers. Preferably, at least 50 mass %, more preferably at least 75 mass %, most preferably all coated polyethylene fibers are coated staple polyethylene fibers because it was observed that the comfort of the inventive fabric increases with increasing the mass % of coated staple polyethylene fibers.

According to the invention, the polymeric sheath covering the fibers comprises a fluoropolymer. Example of fluoropolymers (also known as fluorinated polymers) include both fluoroplastics (also known as fluorothermoplastics) and fluoroelastomers (or fluororubbers). Fluoropolymers for example include both vinylidene fluoride containing fluoropolymers and substantially non-vinylidene fluoride containing fluoropolymers and mixtures thereof. Blends of various fluoropolymers may be employed in the invention if desired. Examples of fluoropolymers can be found in U.S. Pat. No. 6,346,328 from line 34 of column 3 to line 61 of column 5, the disclosure of which is included herein by reference. Further examples of fluoropolymers include polytetrafluoroethylene (PTFE), e.g. Teflon® from DuPont; perfluoroalkoxy polymer resin (PFA); fluorinated ethylene-propylene (FEP); polyethylenetetrafluoroethylene (ETFE) e.g. Tefzel® from DuPont or Fluon® from Asahi Glass Company; polyvinylfluoride (PVF), e.g. Tedlar® from DuPont; polyethylenechlorotrifluoroethylene (ECTFE), e.g. Halar® from Solvay Solexis; polyvinylidene fluoride (PVDF), e.g. Kynar® from Arkema; polychlorotrifluoroethylene (PCTFE); designation (FFKM), e.g. Kalrez® from DuPont, Tecnoflon® from Solvay Solexis; (FPM/FKM), e.g. Viton® from DuPont.

Preferably, the fluoropolymer used according to the invention is PTFE as such fibers exhibit outstanding resistance to delamination of the coating and accordingly a fabric manufactured thereof can be used to particular advantage in applications where said fabric is subjected to a cyclic load, e.g. in a push-pull mode.

The sheath may also comprise other ingredients as for example a binder, solvents, surfactants, dispersants, anti-clogging agents, etc. A preferred ingredient to be added to the sheath is a curable silicone as good results were obtained thereof. It also observed that if the sheath comprises a curable silicon instead of a flouropolymer also good results are obtained.

By sheath is herein understood a coating of certain thickness deposited on the surface of an individual fiber and enclosing the circumference thereof. It is therefore implicit that a sheath according to the present invention does not include wraps or windings around the individual fiber of an e.g. elongated object such as a fiber or a tape containing a fluoropolymer.

According to the invention, the fibers are at least partially coated; preferably the surfaces of the fibers are at least 50%, more preferably at least 75% coated by the sheath. It was observed that the best results are obtained when the entire surface of the fibers is coated by the sheath. To determine the percentage of the surface coverage, the skilled person may for example determine the coverage of a representative length of the fiber, e.g. 1 meter length in case of filaments or the length of the fiber in case of staple fibers, by using for example an optical microscope optionally provided with grated oculars, optical filters, a device for capturing images, e.g. a CCD camera, and software for image analysis, e.g. Image Pro.

Hereinafter, the Figure is detailed.

Figure represents a fiber partially coated by the polymeric sheath.

Without imposing any limitation, Figure depicts a fiber (100) coated partially with a sheath (200). By partial coverage is herein understood that the sheath comprises for example voids (201). By void is herein understood a region in said sheath wherein the surface (101) of the fiber is exposed. Small islands of the polymeric material of the sheath may be present inside a void (not shown in Figure).

The sheath may cover the surface of the polyethylene fiber evenly or unevenly, i.e. along a representative length (300) of the fiber the sheath may comprise low spots (202) which are regions of the sheath with thicknesses (302) lower than the average thickness (301) of the sheath. Preferably, the minimum thickness of the spots is less than one-half the average sheath thickness. A method of detecting non-uniformities in a polymeric sheath is disclosed for example in WO 2000/40951 which is incorporated herein by reference.

If the sheath comprises voids, preferably, the voids have a maximum radial length between the edges thereof, i.e. the longest length along the exposed circumference of the fiber of less than the circumference of the fiber. Preferably, the maximum axial length of the voids, i.e. the longest length between the edges thereof along the exposed surface of the fiber and parallel with the axial length of the fiber, is less than the circumference of the fiber. By circumference of the fiber is herein understood the perimeter of the cross section of the fiber.

The thickness of the sheath is at least 10 nm, preferably at least 50 nm, most preferably at least 0.2 μm. If thinner than 10 nm said sheath may have a reduced stability on the fibers. Although an upper limit need not be imposed, for practical reasons said thickness is preferably at most 20 μm, more preferably at most 10 μm, most preferably at most 5 μm. It was observed that for the preferred ranges, a good stability of the sheath on the fibers is obtained. Also good results in terms of comfort and cut resistance were obtained thereof. The thickness of the coating may be easily measured by light microscopy, SEM or TEM (scanning or transmission electron microscopy) or other known techniques in the art. To increase the optical contrast between the sheath and the fiber, the sheath may be stained or dyed.

The polymeric sheath can be deposited onto the fibers by known techniques, for example as the one described in U.S. Pat. No. 7,329,435 incorporated herein by reference. Further examples of deposition methods include passing a yarn comprising fibers through a bath containing a composition comprising the fluoropolymer and subsequently drying said yarn. To ensure a more homogeneous coating, the fibers of the yarn may be spread during the deposition process. Preferably said composition comprises a dispersion of the fluoropolymer, preferably the dispersion is an aqueous dispersion. Yet further examples of deposition methods include contacting the fibers with a coating roll that is wet by said composition; immersing the fibers in a dip tank comprising said composition; or spraying the fibers during spinning, drawing and/or winding processes with said composition. The technical literature in the art of deposition methods teaches the skilled person how to adjust said methods in order to produce polymeric sheaths with desired thickness and uniformities.

The invention in particular relates to a method of producing the fabric of any of the preceding claims, the method comprising the steps of coating polyethylene fibers with composition comprising an aqueous dispersion of a fluoropolymer by contacting the fibers with said composition; drying the fibers to form a solid sheath; and constructing a fabric from the fibers.

It was observed that good results are obtained if the amount of said composition applied per fiber is at least 0.1 mass % based on the mass of the fiber, preferably 0.5 mass %, more preferably at least 0.8 mass %. Preferably said amount is at most 10 mass % based on the mass of the fiber, more preferably at most 7 mass %, most preferably at most 4 mass %.

According to the invention the fabric comprises polyethylene fibers. Said fibers may be manufactured by any technique known in the art, preferably by melt or gel spinning. If a melt spinning process is used, the polyethylene starting material used for manufacturing thereof preferably has a weight-average molecular weight between 60,000 and 600,000, more preferably between 60,000 and 300,000. An example of a melt spinning process is disclosed in EP 1,350,868 incorporated herein by reference. If the gel spinning process is used to manufacture said fibers, preferably an UHMWPE is used with an intrinsic viscosity (IV) of preferably at least 3 dl/g, more preferably at least 4 dl/g, most preferably at least 5 dl/g. Preferably the IV is at most 40 dl/g, more preferably at most 25 dl/g, more preferably at most 15 dl/g. Preferably, the UHMWPE has less than 1 side chain per 100 C atoms, more preferably less than 1 side chain per 300 C atoms. Preferably the UHMWPE fibers are manufactured according to a gel spinning process as described in numerous publications, including EP 0205960 A, EP 0213208 A1, U.S. Pat. No. 4,413,110, GB 2042414 A, GB-A-2051667, EP 0200547 B1, EP 0472114 B1, WO 01/73173 A1, EP 1,699,954 and in “Advanced Fibre Spinning Technology”, Ed. T. Nakajima, Woodhead Publ. Ltd (1994), ISBN 185573 182 7.

The advantage of using melt spun polyethylene fibers to construct the inventive fabric is that a fabric having a better comfort is achieved. When gel spun UHMWPE fibers are used for manufacturing thereof, a fabric with further improved lifetime and cut resistance is obtained. Good results, in particular in terms of the fabric's lifetime, were also obtained when combinations of melt spun and gel spun polyethylene fibers were used.

The titer of the polyethylene fibers is preferably at least 0.5 dpf, more preferably at least 1.0 dpf, most preferably at least 1.5. The advantage thereof is that when low dpf fibers are used in the inventive fabric, the comfort of the fabric is improved. Preferably said titer is at most 20 dpf, more preferably at most 10 dpf, most preferably at most 5 dpf.

The fabric may also contain fibers manufactured from other natural or synthetic materials suitable for making thereof. Examples of natural fibers include but not limited to fibers of cellulose, cotton, hemp, wool, silk, jute, sisal, cocos, linen and the like. Examples of fibers of synthetic polymers include but not limited to fibers manufactured for example from polyamides and polyaramides, e.g. poly(p-phenylene terephthalamide) (known as Kevlar®); poly(tetrafluoroethylene) (PTFE); poly{2,6-diimidazo-[4,5b-4′,5′e]pyridinylene-1,4(2,5-dihydroxy)phenylene} (known as M5); poly(p-phenylene-2, 6-benzobisoxazole) (PBO) (known as Zylon®); poly(hexamethyleneadipamide) (known as nylon 6,6), poly(4-aminobutyric acid) (known as nylon 6); polyesters, e.g. poly(ethylene terephthalate), poly(butylene terephthalate), and poly(1,4 cyclohexylidene dimethylene terephthalate); polyvinyl alcohols; but also polyolefins e.g. homopolymers and copolymers of polyethylene and/or polypropylene. In a preferred embodiment, the inventive fabric also comprises uncoated polyethylene and/or UHMWPE fibers.

In a preferred embodiment, the inventive fabric contains also polyester and/or polyamide fibers, preferably such fibers having a titer lower than 1 dpf, as such combination gives improved comfort.

In a further preferred embodiment the fabric of the invention contains also cellulose fibers, preferably regenerated cellulose and more preferably viscose. Preferably the fabric further contains other natural fibers as those enumerated hereinabove. The advantage thereof is that the comfort of the fabric is improved while the fabric has an improved coatability.

The fabric of the invention may be of any construction known in the art, e.g. woven, knitted, plaited, braided or non-woven or combinations thereof. Woven fabrics may include plain weave, rib, matt weave and twill weave fabrics and the like. Knitted fabrics may be weft knitted, e.g. single- or double-jersey fabric or warp knitted. An example of a non-woven fabric is a felt fabric. Further examples of woven, knitted or non-woven fabrics as well as the manufacturing methods thereof are described in “Handbook of Technical Textiles”, ISBN 978-1-59124-651-0 at chapters 4, 5 and 6, the disclosure thereof being incorporated herein as reference. A description and examples of braided fabrics are described in the same Handbook at Chapter 11, more in particular in paragraph 11.4.1, the disclosure thereof being incorporated herein by reference.

Preferably the fabric of the invention is a knitted fabric, more preferably a woven fabric, even more preferably the woven fabric is constructed with a small weight per unit length and overall cross-sectional diameter. It was observed that such a fabric shows a low weight per unit coverage surface area and increased degree of flexibility and softness while having an improved cut resistance when compared with known fabrics of the same construction.

A fabric manufactured from yarns containing UHMWPE fibers wherein not the individual fibers are coated with a fluoropolymer but a film comprising a fluoropolymer is laminated directly on the fabric, already exists. An example of such fabric is known from WO 1995/11847 disclosing a fabric coated with a PTFE film laminated thereon, the fabric being formed from high strength yarns (manufactured by DSM Dyneema®, the Netherlands) consisting of UHMWPE fibers.

It was observed however that such laminated fabrics show an increased stiffness and a reduced ability to wrap around. Moreover, the openings between the fibers of the yarns contained in the fabric are completely closed and therefore the fabric is less breathable and said fibers have a restricted ability to pivot with respect to each other. Therefore, articles of apparel containing such fabrics have a decreased comfort. Another disadvantage is that the PTFE films do not adhere well to the fabric and during time, delamination of said film occurs.

The invention relates further to articles and in particular to articles of apparel or rugged outerwear comprising the inventive fabric. Examples of such articles include but are not limited to gloves, aprons, chaps, pants, boots, gators, shirts, jackets, coats, socks, shoes, undergarments, vests, waders, hats, gauntlets, and the like.

The invention also relates to the use of the inventive fabric in articles of apparel or rugged outerwear and in particular in the examples mentioned hereinabove.

In particular, the invention relates to gloves comprising the fabric of the invention. It was observed that the gloves of the invention show an improved grip compared with gloves laminated with films comprising a fluoropolymer. A further advantage of the inventive gloves is that they show improved comfort and also improved breathability. Also their cleanability is improved over gloves containing uncoated fibers, as they are less prone to collect dirt and grime. Preferably, the fabric contained by the gloves is a knitted fabric because a better fit and flexibility of the glove is obtained.

It was observed that improved results in terms of cut resistance and/or comfort are obtained when the inventive fabric is constructed from a yarn containing a first fiber that preferably forms the core of the yarn, said first fiber being selected out of the group consisting of metal fibers, elastan fibers and/or mineral fibers, e.g. glass fibers wherein said yarn further comprises individual fibers of polyethylene coated with a sheath comprising a fluoropolymer, said sheet having a thickness of preferably at least 10 nm, more preferably at least 50 nm, most preferably at least 0.2 μm. The invention therefore relates to such a yarn, hereinafter called the inventive yarn. Preferably, the coated individual polyethylene fibers are wrapped around the core of the yarn. It was observed that the coated individual polyethylene fibers spread more homogeneously around the core of the yarn and the yarn shows improved evenness, i.e. less thick/thin variations in its thickness. Accordingly the processability of the yarn is improved. The invention also relates to a fabric manufactured from the inventive yarn and articles of apparel as those mentioned hereinabove, in particular gloves, comprising said fabric.

It was moreover surprisingly observed that fabrics comprising natural and/or synthetic fibers as those enumerated hereinabove, said fibers being at least partially coated with a polymeric sheath comprising a fluoropolymer, said sheet having a thickness of preferably at least 10 nm, more preferably at least 50 nm, most preferably at least 0.2 μm, show an improved comfort while having increased cut resistance. Therefore the invention relates to such fabrics and to the use of fluoropolymers for increasing the comfort and/or cut resistance of fabrics.

The invention is further explained with the help of the following Example and Comparative Experiment, without being however limited thereto.

### Test Methods

IV (for UHMWPE) is determined according to method PTC-179 (Hercules Inc. Rev. Apr. 29, 1982) at 135° C. in decalin, the dissolution time being 16 hours, with DBPC as anti-oxidant in an amount of 2 g/l solution, by extrapolating the viscosity as measured at different concentrations to zero concentration
Cut resistance determined in accordance with ASTM F-1790(updated 2004).

### EXAMPLE

The UHMWPE fibers of a yarn known as Dyneema® SK-75 were coated with an aqueous dispersion composition of PTFE. Said dispersion is commercially known under the name of Eternitex ECM (code 69-000/D7995) and manufactured by Whitford.

The fibers were coated by dipping them in a water bath containing said dispersion in a ratio water:dispersion of 1:1 and then pressed between two rollers to enhance the spreading of the dispersion on the fibers. The amount of composition per fiber was about 1.4 mass %. The thickness of the sheath on the fibers was about 0.18 μm.

A fabric was knitted on a 13″ Shima Seikai knitting machine, the fabric having an areal density of 260 g/m².

The cut resistance of the fabric measured according to ASTM F-1790 was 3.623 N.

### COMPARATIVE EXPERIMENT

Example 1 was repeated with a yarn with uncoated fibers.

The cut resistance of the fabric measured according to ASTM F-1790 was 2.9 N.

From the above example and comparative experiment it can be observed that a fabric containing polyethylene fibers coated with a sheath comprising a fluoropolymer resists against cutting with a higher force than when the fabric is manufactured from uncoated polyethylene fibers.

Therefore, the inventive fabric can be manufactured with a smaller areal density or a smaller thickness, yet still providing the same cut resistance of a thicker fabric manufactured of uncoated polyethylene fibers.

1. A cut resistant fabric comprising polyethylene fibers characterized in that said fibers are at least partially coated with a polymeric sheath comprising a fluoropolymer wherein the thickness of the sheath is at least 10 nm.

2. The fabric of claim 1 wherein at least 50 mass % of the polyethylene fibers are coated.

3. The fabric of claim 1, said fabric comprising yarns containing individual polyethylene fibers, said individual fibers being coated with a polymeric sheath comprising a fluoropolymer wherein the thickness of the sheath is at least 10 nm.

4. The fabric of claim 1, wherein the coated polyethylene fibers comprise at least 50 mass % of coated polyethylene staple fibers.

5. The fabric of claim 1, wherein the surfaces of the fibers are at least 50% coated by the sheath.

6. The fabric of claim 1, wherein the polyethylene fibers are melt spun polyethylene fibers and/or gel spun ultrahigh molecular weight polyethylene (UHMWPE) fibers.

7. The fabric of claim 1, wherein the fabric comprises further fibers chosen from the group containing polyester fibers, polyamide fibers and cellulose fibers.

8. The fabric of claim 1, wherein the sheath further comprises a curable silicone.

9. The fabric of claim 1, wherein the fabric is a woven or knitted fabric.

10. A method of producing the fabric of claim 1, the method comprising the steps of coating polyethylene fibers with composition comprising an aqueous dispersion of a fluoropolymer by contacting the fibers with said composition; drying the fibers to form a solid sheath; and constructing a fabric from the fibers.

11. The method of claim 8 wherein the amount of composition applied per fiber is at least 0.1 mass % based on the mass of the fiber

12. Articles of apparel or rugged outerwear comprising the fabric of claim 1.

13. Use of the fabric of claim 1, in articles of apparel or rugged outerwear.

14. Gloves comprising the fabric of claim 1.

15. A yarn containing a fiber selected out of the group consisting of metal fibers, elastan fibers and/or mineral fibers characterized in that said yarn further comprises fibers of polyethylene coated with a sheath comprising a fluoropolymer.
